(19) United States
(12) Patent Application Publication
(10) Pub. No.: US 2015/0149261 A1
(43) Pub. Date: May 28, 2015

(54) MEASURING QUALITY OF CONTENT ITEMS PRESENTED BY A DIGITAL MAGAZINE SERVER

(71) Applicant: Flipboard, Inc., Palo Alto, CA (US)

(72) Inventors: Andrew David Walkingshaw, San Francisco, CA (US); Xiaoyu Fei, Palo Alto, CA (US)

(73) Assignee: Flipboard, Inc., Palo Alto, CA (US)

(21) Appl. No.: 14/089,564

(22) Filed: Nov. 25, 2013

(51) Int. Cl. G06Q 10/06

(52) U.S. Cl. CPC G06Q 10/06395
USPC 705/7.41

(57) ABSTRACT

A digital magazine server determines a quality score for content items receiving less than a threshold amount of interactions from digital magazine server users. A distribution of quality scores for a content item is determined from quality scores of content items having one or more characteristics matching characteristics of the content item. As users interact with a content item, the distribution of quality scores is modified to reflect the received interaction. The digital magazine server may use the distribution for a content item to determine a quality score for the content item having a specified confidence or the confidence of the content item having a specified quality score.

### BACKGROUND

This invention relates generally to digital magazines, and more particularly to determining quality of content items added to a digital magazine server.

A digital magazine server generates a digital magazine including various pages having content items selected for a user based on preferences or parameters defined by the user. Publishers of content items may provide additional content items to the digital magazine server, increasing the potential content items for presentation to users of the digital magazine server. For example, a content publisher provides new content items to the digital magazine server. Alternatively, the digital magazine server may identify additional content items having one or more characteristics in common with content items previously provided to a user in one or more pages of a digital magazine.

To increase a likelihood of user interaction with content items presented in the digital magazine, the digital magazine server determines a quality of the additional content items that represents the perception of various content items. For example, a quality of a content item indicates the popularity of the content item among users of the digital magazine server. The quality of a content item is a factor in selection of content items for presentation to users to maintain user engagement with presented content items. However, conventional methods for assessing quality of content items added to the digital magazine server require a history of interaction with each content item by users of the digital magazine server. Thus, these conventional methods are ill-suited for determining quality of additional content items having received few, or no, interactions from digital magazine server users.

### SUMMARY

A digital magazine server creates a digital magazine for a user including content items for presentation to the user. For example, the digital magazine server organizes content items having at least one common characteristic into various sections, and presents content items to the user according to the sections. To maintain user interaction with content items, the digital magazine server provides and recommends content items to the user, such as content items that have not previously been presented to the user. For example, the digital magazine server receives content items from various sources and selects content items from the received content items for presentation to a user. When selecting content items for presentation to the user, a content item's quality, which provides a measure of how users of the digital magazine server perceive the content item, is used when determining whether to present the content item to the user. However, a content item received from a source may have less than a threshold amount of interaction by digital magazine server users, so user interactions with content items having one or more characteristics similar to a characteristic of the content item are used to determine the quality of the content item with less than the threshold amount of user interaction.

When the digital magazine server receives a content item having less than a threshold amount of interaction by digital magazine server users, a characteristic of the received content item is determined. For example, the characteristic is a topic of the received content item. To assess quality of the received content item, a set of previously presented content items having a characteristic matching the characteristic determined for the received content item is identified. As the quality of a content item represents a status or perception of the content item by users in the digital magazine, interactions with the set of previously presented content items by digital magazine server users are determined. For example, a content item's popularity among digital magazine server users represents the quality of the content item. Hence, in one embodiment, a number of interactions indicating a preference for each previously presented content item in the set of previously content items and a total number of interactions with the set of previously presented content items are determined. Examples of interactions indicating preference for a content item include accessing the content item, accessing the content item for at least a threshold interval of time, sharing the content item with another digital magazine server user, expressing a preference for the content item, and saving the content item.

A quality score for each of the previously presented content items is determined based on the number of interactions indicating preference for a previously presented content item. In one embodiment, a quality score for a content item is a ratio of the number of interactions indicating preference for the previously presented content item to a total number of interactions with the previously presented content item or a ratio of the number of interactions indicating preference for the previously presented content item to a total number of interactions with the set of previously presented content items. A distribution of quality scores for the received content item is generated by statistically analyzing the quality scores for content items in the set of previously presented content items. The generated distribution provides an indication of a confidence score that the received content item has a specified quality score. Additionally, the generated distribution allows determination of a quality score associated with the received content item that the received content item has a specified confidence score.

When a user of the digital magazine server interacts with the received content item, a quality score for the received content item is determined. For example, when a digital magazine server user indicates a preference for the received content item to the digital magazine server, a quality score is determined for the received content item based on the indication of preference by the user. In one embodiment, the quality score for the received content item is determined based on a ratio of a number of interactions indicating preference for the received content item to a normalization factor. Alternatively, the quality score for the received content item may be determined by determining a total number of interactions indicating preference from the interactions indicating preference for the received content item and the interactions indicating preference for content items in the set of previously presented content items; the quality score for the received content item is then determined as a ratio of the total number of interactions indicating preference to the normalization factor. In various embodiments, the normalization factor is a total number of interactions with the received content item, a total number of interactions with content items in the set of content items, or any other suitable value. The distribution of quality scores is modified based on the quality score of the received content item to generate a modified distribution for determining the quality score of a subsequently received content item. For example, to determine an additional content item for presentation to a user, the digital magazine server receives a query from an application executing on a client device associated with the user that specifies a quality score with a specified confidence score for a content item or that specifies a confidence score for a specified quality score for a content item; based on the information in the query and a distribution of quality scores of content items having a matching characteristic with the additional content item, the additional content item is selected for presentation to the user.

### BRIEF DESCRIPTION OF THE DRAWINGS

FIG. 1 is a block diagram of a system environment in which a digital magazine server operates, in accordance with an embodiment of the invention.

FIG. 2 is a block diagram of a digital magazine server, in accordance with an embodiment of the invention.

FIG. 3 is an example of presentation of content items in a digital magazine using a page template, in accordance with an embodiment of the invention.

FIG. 4 is a flow chart of a method of assessing quality of a content item for presentation by a digital magazine server, in accordance with an embodiment of the invention.

FIGS. 5A and 5B are an example of modifying a distribution of quality scores for a content item, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A digital magazine server retrieves content from one or more sources and generates a personalized, customizable digital magazine for a user based on the retrieved content. The generated digital magazine is retrieved by a digital magazine application executing on a computing device (such as a mobile communication device, tablet, computer, or any other suitable computing system) and presented to the user. For example, based on selections made by the user and/or on behalf of the user, the digital server application generates a digital magazine including one or more sections including content items retrieved from a number of sources and personalized for the user. The generated digital magazine allows the user to more easily consume content that interests and inspires the user by presenting content items in an easily navigable interface via a computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### System Architecture

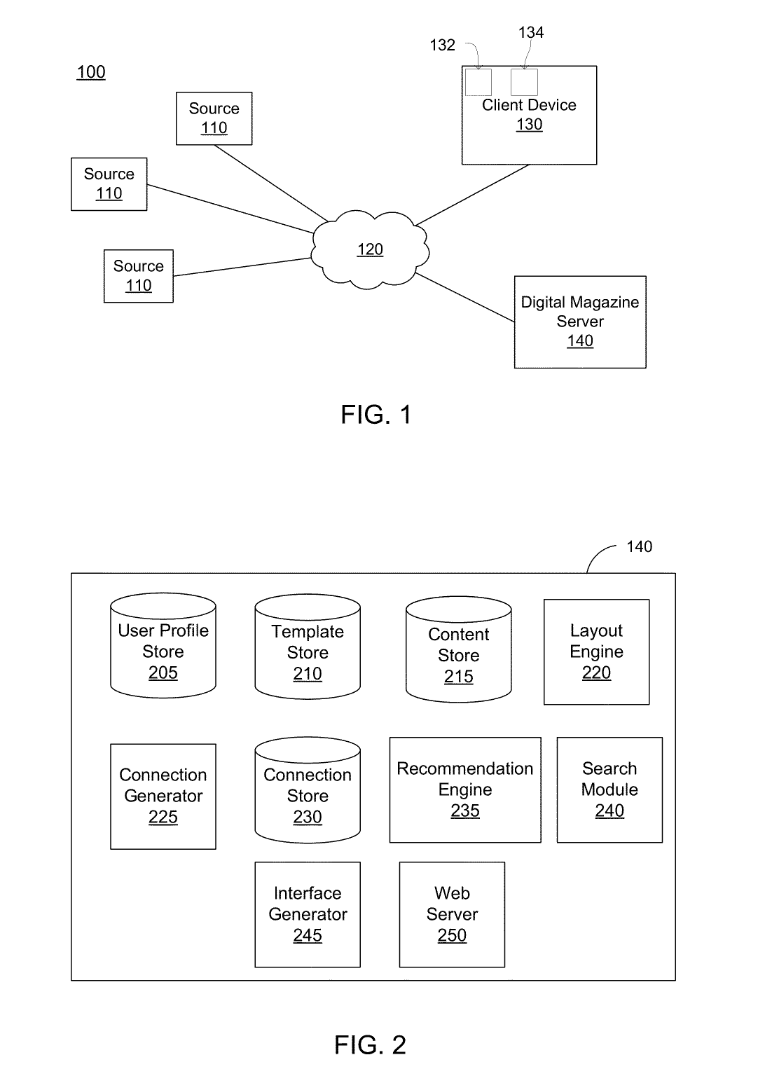

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine severs 140.

A source 110 is a computing system capable of providing various types of content to a client device 130. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” A content item may include various types of content, such as text, images, and video.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 130 is one or more computing devices capable of receiving user input as well as transmitting and/or receiving data via the network 120. In one embodiment, the client device 110 is a conventional computer system, such as a desktop or a laptop computer. Alternatively, the client device 130 may be a device having computer functionality, such as a personal digital assistant (PDA), a mobile telephone, a smartphone or another suitable device. In one embodiment, the client device 130 executes an application allowing a user of the client device 110 to interact with the digital magazine server 140. For example, an application executing on the client device 130 communicates instructions or requests for content items to the digital magazine server 140 to modify content presented to a user of the client device 130. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 110, such as IOS® or ANDROID™. While FIG. 1 shows a single client device 130, in various embodiments, any number of client devices 130 may communicate with the digital magazine server 140.

A display device 132 included in the client device 130 presents content items to a user of the client device 130. Examples of the display device 132 include a liquid crystal display (LCD), an organic light emitting diode (OLED) display, an active matrix liquid crystal display (AMLCD), or any other suitable device. Different client devices 130 may have display devices 132 with different characteristics. For example, different client devices 132 have display devices 132 with different display areas, different resolutions, or differences in other characteristics.

One or more input devices 134 included in the client device 130 receive input from the user. Different input devices 134 may be included in the client device 130. For example, the client device 130 includes a touch-sensitive display for receiving input data, commands, or information from a user. Using a touch-sensitive display allows the client device 130 to combine the display device 132 and an input device 134, simplifying user interaction with presented content items. In other embodiments, the client device 130 may include a keyboard, a trackpad, a mouse, or any other device capable of receiving input from a user. In another example, the input device 134 is configured to receive information from a user of the client device through a touchless interface. Examples of a touchless interface include sensors, such as an image capture device, to receive gestures from a client device user without the user physically contacting the display device 132 or the client device 130. Additionally, the client device may include multiple input devices 134 in some embodiments. Inputs received via the input device 134 may be processed by a digital magazine application associated with the digital magazine server 140 and executing on the client device 130 to allow a client device user to interact with content items presented by the digital magazine server 140.

The digital magazine server 140 receives content items from one or more sources 110, generates pages in a digital magazine by processing the received content, and provides the pages to the client device 130. As further described below in conjunction with FIG. 2, the digital magazine server 140 generates one or more pages for presentation to a user based on content items obtained from one or more sources 110 and information describing organization and presentation of content items. For example, the digital magazine server 140 determines a page layout specifying positioning of content items relative to each other based on information associated with a user and generates a page including the content items arranged according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to a print magazine, the digital magazine server 140 allows a user to interact with content items from multiple sources 110 via the client device 130 with less inconvenience from horizontally or vertically scrolling to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding social networking system user. Examples of information stored in a user profile include biographic, demographic, and other types of descriptive information, such as gender, hobbies or preferences, location, or other suitable information. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred.

While user profiles in the user profile store 205 are frequently associated with individuals, allowing individuals to provide and receive content items via the digital magazine server 140, user profiles may also be stored for entities such as businesses or organizations. This allows an entity to provide or access content items via the digital magazine server 140. An entity may post information about itself, about its products or provide other content items associated with the entity to users of the digital magazine server 140. For example, users of the digital magazine server 140 may receive a digital magazine or section including content items associated with an entity via the digital magazine server 140.

The template store 210 includes page templates each describing a spatial arrangement (“layout”) of content items relative to each other on a page for presentation by a client device 130. A page template includes one or more slots, each configured to present one or more content items. In some embodiments, slots in a page template may be configured to present a particular type of content item or to present a content item having one or more specified characteristics. For example, a slot in a page template is configured to present an image while another slot in the page template is configured to present text data. Each slot has a size (e.g., small, medium, or large) and an aspect ratio. One or more page templates may be associated with types of client devices 130, allowing content items to be presented in different relative locations and with different sizes when the content items are viewed using different client devices 130. Additionally, page templates may be associated with sources 110, allowing a source 110 to specify the format of pages presenting content items received from the source 110. For example, an online retailer is associated with a page template to allow the online retailer to present content items via the digital magazine server 140 with a specific organization. Examples of page templates are further described in U.S. patent application Ser. No. 13/187,840, filed on Jul. 21, 2011, which is hereby incorporated by reference in its entirety.

The content store 215 stores objects that each represent various types of content. For example, the content store 215 stores content items received from one or more sources 115 within a threshold time of a current time. Examples of content items stored by the content store 215 include a page post, a status update, a photograph, a video, a link, an article, video data, audio data, a check-in event at a location, or any other type of content. A user may specify a section including content items having a common characteristic, and the common characteristic is stored in the content 215 store along with an association with the user profile or the user specifying the section.

The layout engine 220 retrieves content items from one or more sources 110 or from the content store 215 and generates a page including the content items based on a page template from the template store 210. Based on the retrieved content items, the layout engine 220 may identify candidate page templates from the template store 210, score the candidate page templates based on characteristics of the slots in different candidate page templates and based on characteristics of the content items. Based on the scores associated with candidate page templates, the layout engine 220 selects a page template and associates the retrieved content items with one or more slots to generate a page where the retrieved content items are presented relative to each other and sized based on their associated slots. When associating a content item with a slot, the layout engine 220 may associate the content item with a slot configured to present a specific type of content item or to present content items having one or more specified characteristics. An example of using a page template to present content items is further described in U.S. patent application Ser. No. 13/187,840, filed on Jul. 21, 2011, which is hereby incorporated by reference in its entirety.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing user interaction with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with interactions. The connection generator 225 generates a connection between a user and a content item if the user's interactions with the content item satisfy one or more criteria. In one embodiment, the connection generator 225 determines one or more weights specifying a strength of the connection between the user and the content item based on user interactions with the content item that satisfy one or more criteria. Generation of connections between a user and a content item is further described in U.S. patent application Ser. No. 13/905,016, filed on May 29, 2013, which is hereby incorporated by reference in its entirety.

If multiple content items are connected to a user, the connection generator 225 establishes implicit connections between each of the content items connected to the user. In one embodiment, the connection generator 225 maintains a user content graph identifying the implicit connections between content items connected to a user. In one embodiment, weights associated with connections between a user and content items are used to determine weights associated with various implicit connections between content items. User content graphs for multiple users of the digital magazine server 140 are combined to generate a global content graph describing connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or from multiple user content graphs and stores the adjacency matrix in the connection store 230. The adjacency matrix describes connections between content items. For example, the adjacency matrix includes identifiers of content items and weights representing the strength or closeness of connections between content items based on the global content graph. As an example, the weights indicate a degree of similarity in subject matter or similarity of other characteristics associated with various content items. In other embodiments, the connection store 230 includes various adjacency matrices determined from various user content graphs; the adjacency matrices may be analyzed to generate an overall adjacency matrix for content items provided by the digital magazine server 140. Graph analysis techniques may be applied to the adjacency matrix to rank content items, to recommend content items to a user, or to otherwise analyze relationships between content items. An example of the adjacency matrix is further described in U.S. patent application Ser. No. 13/905,016, filed on May 29, 2013, which is hereby incorporated by reference in its entirety.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a first and a second user by analyzing the first user's interactions with content items posted by the second user, whether the content item is posted using the digital magazine server 140 or on another social networking system. Additional examples for determining social proximity between users of the digital magazine server 140 are described in U.S. patent application Ser. No. 13/905,016, filed on May 29, 2013, which is incorporated by reference in its entirety. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile and data describing connections between content items, and/or connections between users from the connection store 230. In one embodiment, the recommendation engine 235 uses stored information describing content items (e.g., topic, sections, subsections) and interactions between users and various content items (e.g., views, shares, saved, links, topics read, or recent activities) to identify content items that may be relevant to a digital magazine server user. For example, content items having an implicit connection of at least a threshold weight to a content item with which the user interacted are recommended to the user. As another example, a the recommendation engine 235 presents a user with content items having one or more attributes in common with a content item with which an additional user having a threshold connection confidence score with the user interacted. Recommendations for additional content items may be presented to a user when the user views a content item using the digital magazine, may be presented as a notification to the user by the digital magazine server 140, or may be presented to the user through any suitable communication channel.

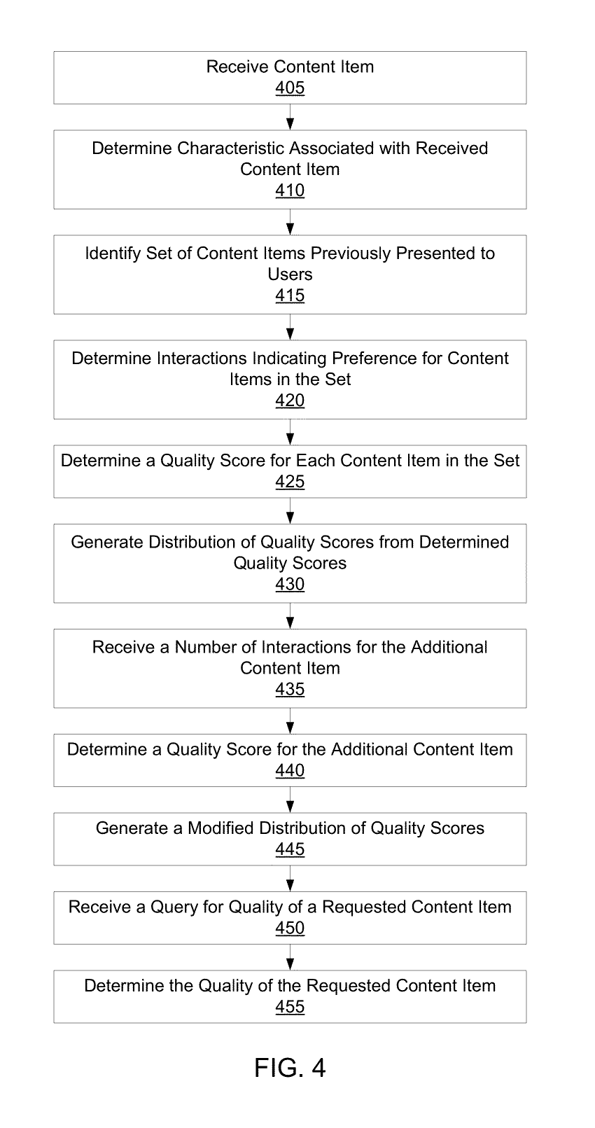

The recommendation engine 235 may determine a quality score for content items in the content store 215 or retrieved from sources 110 that provides a measure of the perception of various content items by digital magazine server users (e.g., the popularity of different content items among digital magazine server users). Determination of a quality score for a content item is further described below in conjunction with FIG. 4. When recommending content items to a user, quality scores associated with content items may be used as a factor by the recommendation engine 235 to identify content items for recommendation to the user. For example, the recommendation engine 235 identifies content items having a threshold quality score or content items having a specified quality score to the user, as further described below in conjunction with FIG. 4.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user retrieved from the user's user profile. Examples of attributes of content items include a type (e.g., image, story, link, video, audio, etc.), a source 110 from which a content item was received, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or may be further analyzed based on user characteristics and on content item attributes to generate more refined set of recommended content items. A setting included in a user's user profile may specify a length of time that content items are analyzed before identifying recommended content items to the user, allowing a user to balance refinement of recommended content items with time used to identify recommended content items.

The search module 240 receives a search query from a user and retrieves content items from one or more sources 110 based on the search query. For example, content items having at least a portion of an attribute matching at least a portion search query are retrieved from one or more sources 110. The user may specify sources 110 from which content items are received through settings maintained by the user's user profile or by identifying one or more sources in the search query. In one embodiment, the search module 240 generates a section of the digital magazine including the content items identified based on the search query, as the identified content items have a common attribute of their association with the search query. Presenting identified content items identified from a search query allows a user to more easily identify additional content items at least partially matching the search query when additional content items are provided by sources 110.

To more efficiently identify content items based on search queries, the search module 110 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 140 may present identified content items based on a ranking. One or more factors associated with the content items may be used to generate the ranking Examples of factors include: global popularity of a content item among users of the digital magazine server 140, connections between users interacting with a content item and the user providing the search query, and information from a source 110. Additionally, the search module 240 may assign a weight to the index information associated with each content item selected based on similarity between the index information and a search query and rank the content items based on their weights. For example, content items identified based on a search query are presented in a section of the digital magazine in an order based in part on the ranking of the content items.

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device 132 of a client device 130 with modifications to content presented by a digital magazine. As an example, if the input device 132 is a touch-sensitive display, the interface generator 245 includes instructions associating different gestures with navigation through content items or presented via a digital magazine. Instructions from the interface generator 245 are communicated to a digital magazine application or other application executing on a client device 130 on which content from the digital magazine server 140 is presented. Inputs received via an input device 132 of the client device 130 are processed based on the instructions when content items are presented via the digital magazine server 140 is presented to simplify user interaction with content presented by the digital magazine server 140.

The web server 250 links the digital magazine server 140 via the network 120 to the one or more client devices 130, as well as to the one or more sources 110. The web server 250 serves web pages, as well as other content, such as JAVA®, FLASH®, XML and so forth. The web server 250 may retrieve content item from one or more sources 110. Additionally, the web server 250 communicates instructions for generating pages of content items from the layout engine 220 and instructions for processing received input from the interface generator 245 to a client device 130 for presentation to a user. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROID™, WEBOS® or RIM®.

For purposes of illustration, FIG. 2 describes various functionalities provided by the digital magazine server 140. However, in other embodiments, the above-described functionality may be provided by a digital magazine application executing on a client device 130, or may be provided by a combination of the digital magazine server 140 and a digital magazine application executing on a client device 130. For example, the digital magazine server 140 identifies and presents similar documents, independent of the type of document such as a video or text, by comparing a plurality of address information of the documents. In one embodiment, the recommendation engine 235 compares the plurality of address information. In another embodiment, a digital magazine application executing on the client device 130 identifies and presents similar documents. Alternatively, the digital magazine server 140 and the client device 130 operate in conjunction with each other to identify and present similar documents. For example, certain functionality (e.g. identifying similar documents) is performed by the digital magazine server 140, while other functionality (e.g., presenting similar documents) is performed by a digital magazine application executing on the client device 130.

### Page Templates

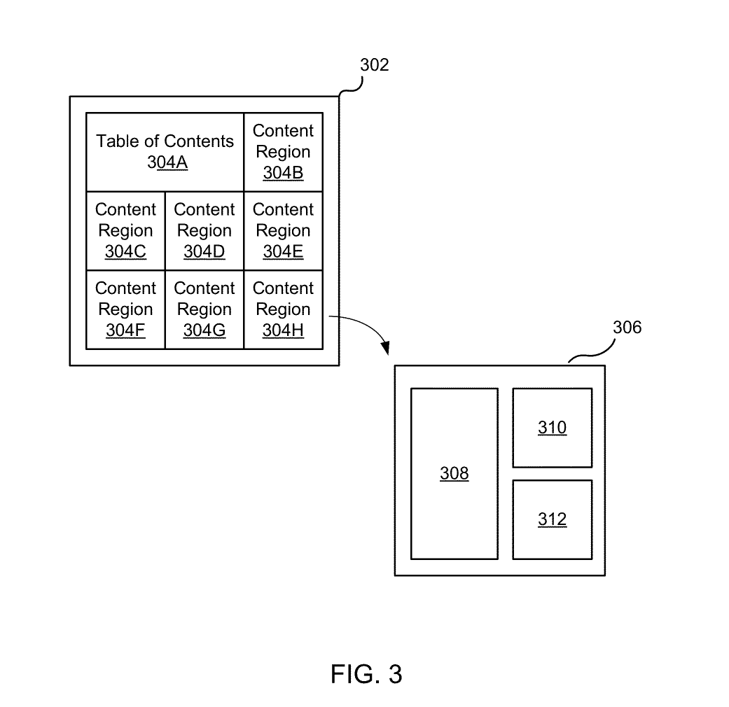

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of content items having specific characteristics or for presentation of a specific type of content item. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 302 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text, data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are received. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions. Information describing sections or subsections, such as a characteristic common to content items in a section or subsection, may be stored in the content store 215 and associated with a user profile to simplify generation of a section or subsection for the user. A page template associated with a subsection may be identified, and slots in the page template associated with the subsection used to determine presentation of content items from the subsection relative to each other. Referring to FIG. 3, the content region 304H includes a content item associated with a newspaper to indicate a section including content items retrieved from the newspaper. When a user interacts with the content region 304, a page template associated with the section is retrieved, as well as content items associated with the section. Based on the page template associated with the section and the content items, the digital magazine server 140 generates a page presenting the content items based on the layout described by the slots of the page template. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

### Measuring Quality of Content Items in a Digital Magazine Server

FIG. 4 is a flowchart of one embodiment of a method for determining quality of content items on the digital magazine server 140. In other embodiments, the method may include different and/or additional steps than those shown in FIG. 4. The functionality described in conjunction with the digital magazine server 140 in FIG. 4 may be provided by the recommendation engine 235, in one embodiment, or may be provided by any other suitable component, or components, in other embodiments. Additionally, the client device 130 may execute one or more instructions associated with the digital magazine server 140, such as an application associated with the digital magazine server 140, to provide the functionality described in conjunction with FIG. 4.

In one embodiment, the digital magazine server 140 receives 405 a content item. For example, the digital magazine server 140 provides a request to the source 110; alternatively, the source 110 communicates a content item to the digital magazine server 140 when a condition is met (e.g., additional content items are received by the source 110, a time interval between a current time and a time when content items were sent to the digital magazine server 140 has passed, etc.). For example, the digital magazine server 140 receives 405 the content item from the source 110 via the network 130. Alternatively, the content item is received 405 from the content store 215 of the digital magazine server 140. However, in various embodiments, the content item may be received 405 from any suitable provider of content items. In some embodiments, an application associated with the digital magazine server 140 and executing on a client device 130 receives 405 the content item from the digital magazine server 140, from a source 110, or from any other suitable provider of content items. The content item may be received 405 when a user has accessed a threshold number of content items via the application associated with the digital magazine server 140, when the application associated with the digital magazine server 140 receives a request for a content item from a user, or based on any other suitable condition. The received content item may be a content item that has not previously been presented to digital magazine server users or has been presented to less than a threshold number of digital magazine server users.

A characteristic associated with the received content item is determined 410 based on attributes of the received content item. Characteristics associated with a content item describe features or attributes of the content item. Example characteristics include a keyword, a topic, an author, or other suitable feature determined from the content item. The characteristic associated with the received content item may be determined 410 using a variety of methods. For example, the characteristic associated with the received content item is determined 410 by calculating a frequency of words appearing in text included in the received content item with words having at least a threshold frequency identified as characteristics of the received content item. As additional examples, the characteristic may be determined 410 from a title of the received content item, from a source 110 associated with the received content item, or from context of the received content item. In one embodiment, the characteristic is stored in the content store 215 and associated with the received content item.

A set of content items previously presented to one or more users of the digital magazine server 140 is identified 415 based at least in part on the characteristic associated with the received content item. Thus, each content item in the set of content items is associated with the characteristic and was previously presented to one or more digital magazine server users. In one embodiment, the set of content items includes one or more content items included in a digital magazine presented to various users of the digital magazine server 140. Alternatively, the set of content items includes content items included in a digital magazine limited to being presented to the user or to a group of users including the user.

A number of interactions indicating preference for each content item in the set of content items is determined 420. Preference for a content item indicates a user's positive assessment of the content item. A user's indication of preference for a content item may be determined based on the user's interaction with the content item. Examples of interactions indicating preference for a content item include accessing the content item, accessing the content item for at least a threshold interval of time, sharing the content item (e.g., e-mail, etc.) with another user, providing an input expressly indicating a preference for the content item, and saving the content item. In one embodiment, the number of interactions indicating preference for a content item is stored in the content store 215 along with an association with the content item.

Based at least in part on a number of interactions indicating preference for a content item in the set of content items, a quality score for each content item in the set of content items is determined 425. The quality score of a content item represents a perception of the content item by users of the digital magazine server 140. A content item's quality score is based at least in part on the number of interactions indicating preference for the content item. For example, the quality score of a content item is a ratio of the number of interactions indicating preference for the content item in the set of content items to a normalization factor. Various values may be used as the normalization factor. In one embodiment, the normalization factor is a total number of interactions with the content item for which the quality score is determined 425, such as a total number of times the content item was accessed. Other embodiments use a normalization factor of a total number of users interacting with the content item for which the quality score is determined 425, a total number of users interacting with the content item for which the quality score is determined 425 in a specified interval of time, a total number of times with which the content item for which the quality score is determined 425 was interacted in a specified interval of time, or other suitable measure of interactions with the content item for which the quality score is determined 425. The quality score of a content item may be stored in the content store 215 along with an association with the content item.

A distribution of quality scores for the received content item is generated 430 based on the determined quality scores for the content items in the set of content items. The distribution of quality scores provides a probability density function of quality for the received content item. Using statistical inference, the distribution of quality scores for the received content item is generated 430 using a probability density function created from a mean, a mode, a standard deviation, and a variance of the quality scores of the content items in the set of content items. In one embodiment, Bayesian inference is used to generate 430 the distribution of quality scores. The generated distribution may be a normal distribution, a square distribution, a triangle distribution, or any other suitable distribution. In the typical embodiment, the generated distribution is a beta distribution; in contexts where Bayesian inference is used, the prior distribution is also modeled as a beta distribution. In one embodiment, the distribution representing quality scores of the received content item is stored in the content store 215 along with an association with the received content item.

When the received content item is presented to one or more users of the digital magazine server 140, an interaction with the received content item is received 435 by the digital magazine server 140. The received interaction may be an interaction indicating preference for the received content item or an interaction that does not indicate preference for the received content item. Example interactions that indicate preference for the received content item include accessing the received content item, accessing the received content item for at least a threshold interval of time, sharing the received content item (e.g., e-mail, etc.) with another user, providing an input expressly indicating a preference for the received content item, and saving the received content item. Example interactions that do not indicate preference for the received content item include accessing the received content item for less than at least a threshold interval of time, accessing the received content item for at least the threshold interval of time and not sharing the received content item, accessing the received content item for at least the threshold interval of time and not saving the received content item, or other interactions with the content item for less than the threshold interval of time. The number of interactions associated with the received content item may be stored in the content store 215 and associated with the received content item.

Based at least in part on the received interaction with the received content item, a quality score for the received content item is determined 440. The quality score for the received content item provides a measure of the received content item's status among users of the digital magazine server 140 that is based at least in part on a number of interactions indicating preference for the received content item. For example, the quality score for the received content item is determined based on a ratio of a number of interactions indicating preference for the received content item to a normalization factor. In another example, the quality score for the received content item is determined based on a ratio of a combined number of interactions indicating preference for the received content item and interactions indicating preference for content items in the set of content items to a normalization factor. Various values may be used for the normalization factor in various embodiments. For example, the normalization factor may be a total number of interactions with the received content item, a total number of interactions with content items in the set of content items, a total number of interactions with the set of content items, or any other suitable value. In one embodiment, the quality score for the received content item is stored in the content store 215 in association with the received content item.

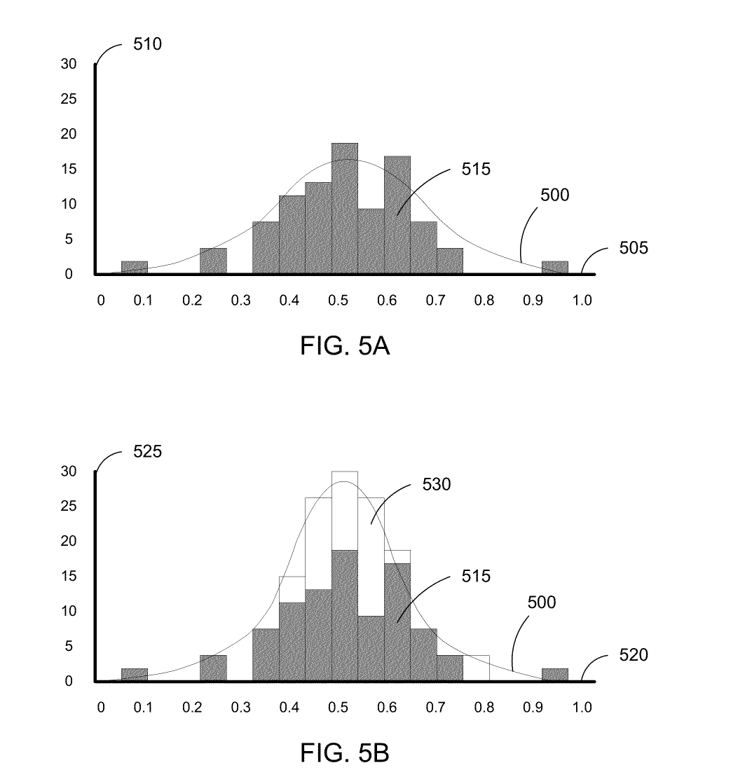

The distribution of quality scores of content items in the set of content items is modified to account for the received interaction with the received content item, generating 445 a modified distribution of quality scores for the received content item. In one embodiment, one or more statistical methods are applied to the distribution of quality scores for content items in the set of content items to generate 445 the modified distribution by updating the distribution of quality scores for content items in the set of content items with the determined quality score of the received content item. For example, Bayesian updating is used to generate 445 the modified distribution based on the distribution of quality scores for content items in the set of content items and the quality score of the received content item. As another example, a mean, a standard deviation, and a variance of the quality scores are recalculated based on the quality score of the received content item and the quality scores of content items in the set of content items. The mean and the mode for the received content item are updated as iterations of the statistical method tighten the distribution curve, as further described in conjunction with FIGS. 5A and 5B. As described above, the modified distribution may be any suitable probability distribution (e.g., a normal distribution, a square distribution, a triangle distribution, a beta distribution, etc.). Thus, the distribution of quality scores for content items in the set of content items stored in the content store 215 may be updated to represent the modified distribution; alternatively, the modified distribution and the distribution of the quality scores of the content item in the set of content items are each stored in the content store 215.

A query for quality of the received content item is received 450. In one embodiment, the query includes a specified confidence or a specified quality score. Alternatively, the query includes both a specified confidence and a specified quality score. A query including a specified confidence requests a quality score of the received content item having the specified confidence, while a query including a specified quality score requests a confidence of the received content item having the specified quality score. The specified confidence may be a cumulative percentage, a standard deviation, or other suitable value associated with a distribution or probability density function. The specified quality score may be a value selected from a range of values included in the modified distribution. The query may be received 450 if one or more conditions are satisfied by the received content item. Examples of conditions include no interactions being associated with the received content item, less than a threshold number of interactions being associated with the received content item, or the received content item being selected for presentation to a user to whom the received content item was not previously presented. In one embodiment, the quality score of the received content item and/or the confidence of the received content item having a quality score determine in part whether the received content item is presented to a user of the digital magazine server 140. In other embodiments, the quality score of the received content item and/or the confidence of the received content item having a quality score is used to identify a magazine in which the received content item is included.

Based at least in part on the modified distribution of quality scores for the received content item, the quality of the received content item is determined 455. If the query for quality includes a specified confidence, a quality score associated with the specified confidence in the modified distribution for the received content item is determined 455. Additionally, if the query for quality includes a specified quality score, a confidence associated with the specified quality score is determined 455 from the modified distribution for the received content.

FIGS. 5A and 5B illustrate an example of modification of a normal distribution 500 of quality scores for a received content item generated based on quality scores of content items in a set of content items previously presented to users of the digital magazine server 140 and having a characteristic matching a determined characteristic of the received content item. As shown in FIGS. 5A and 5B, the normal distribution 500 of the received content item is tightened as interactions are received with the received content item, modifying the standard deviation of the normal distribution of quality scores for the received content item; additionally, the mean of the normal distribution 500 of quality scores may also be modified as interactions with the received content item are received.

FIG. 5A illustrates a distribution 500 generated using the quality scores of content items in the set of content items. Thus, the horizontal axis 505 in FIG. 5A represents quality scores, while the vertical axis 510 in FIG. 5A represents a number of content items having a quality score identified by the horizontal axis 505. FIG. 5B illustrates a distribution 500 of quality scores for a received content item, rather than for content items in the set of content items. The distribution in FIG. 5B is generated in part using quality scores of content items 515 in the set of content items. In the example of FIG. 5B, the vertical axis 525 represents number of times a quality score identified by a position on the horizontal axis 520 is associated with the received content item. As shown in FIG. 5B, the number of times the received content item was associated with a quality score is based on quality scores of content items 515 in the set of content items as well as quality scores for the received content item 530. As the number of quality scores received for the received content item 530 increase based on interactions with the received content item from one or more users of the digital magazine server 140, the distribution curve tightens, as shown in the change in the distribution 500 from FIG. 5A to FIG. 5B.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of assessing quality of one or more content items for presentation by a digital magazine server, the method comprising:
receiving a content item;
determining a characteristic associated with the received content item;
identifying a set of content items previously presented to one or more users of the digital magazine server based at least in part on the characteristic associated with the received content item;
determining a number of interactions indicating preference for each content item in the set of content items;
determining a quality score for each content item in the set of content items, the quality score for a content item in the set of content items determined at least in part on a number of interactions indicating preference for the content item in the set of content items;
generating a distribution of quality scores for the received content item based on the determined quality scores for the content items in the set of content items;
receiving an interaction for the received content item;
determining a quality score for the received content item based at least in part on the interaction;
generating a modified distribution of quality scores for the received content item by modifying the distribution of quality scores for the received content item to include the quality score of the received content item;
receiving a query for quality of the received content item; and
determining the quality of the received content item based at least in part on the modified distribution of quality scores for the received content item.

2. The method of claim 1, wherein an interaction indicating preference for a content item in the set of content items comprises a user of the digital magazine server accessing the content item for at least a threshold time interval.

3. The method of claim 1, wherein the interaction for the received content item comprises an interaction indicating preference for the received content item.

4. The method of claim 3, wherein the interaction indicating preference for the received content item comprises at least a threshold number of users of the digital magazine server accessing the received content item within a specified time interval.

5. The method of claim 3, wherein an interaction indicating preference for the received content item is selected from a group consisting of: receiving an input from a user of the digital magazine server to save the received content item, receiving an input from the user of the digital magazine server to share the received content item with an additional user of the digital magazine server, and any combination thereof.

6. The method of claim 1, wherein the quality score for the received content item is determined based on a ratio of a number of interactions indicating preference for the received content item to a normalization factor.

7. The method of claim 6, wherein the normalization factor comprises a total number of interactions with the received content item.

8. The method of claim 6, wherein the normalization factor comprises a total number of interactions with content items in the set of content items.

9. The method of claim 1, wherein determining the quality score for the received content item based at least in part on the interaction comprises:
determining a total number of interactions indicating preference based on a number of interactions indicating preference for the received content item and the number of interactions indicating preference for content items in the set of content items; and
determining a ratio of the total number of interactions indicating preference and a normalization factor.

10. The method of claim 9, wherein the normalization factor comprises a combination of a number of interactions with the received content item and a number of interactions with content items in the set of content items.

11. The method of claim 9, wherein the normalization factor comprises a total number of interactions with content items in the set of content items.

12. The method of claim 9, wherein the normalization factor comprises a total number of interactions with the content item in the set of content items.

13. The method of claim 1, wherein the quality score for a content item in the set of content items is determined based on a ratio of the number of interactions indicating preference for the content item in the set of content items to a normalization factor.

14. The method of claim 1, wherein a query for quality of the received content item comprises a specified quality score and a specified confidence.

15. A method of assessing quality of one or more content items included in a digital magazine, the method comprising:
receiving a content item;
determining a characteristic associated with the received content item;
identifying a set of content items previously presented to one or more users of a digital magazine server based at least in part on the characteristic associated with the received content item;
determining a number of interactions indicating preference for each content item in the set of content items;
determining a quality score for each content item in the set of content items, the quality score for a content item in the set of content items determined at least in part on a number of interactions indicating preference for the content item in the set of content items;
generating a distribution of quality scores for the received content item based on the determined quality scores for the content items in the set of content items;
receiving an interaction for the received content item;
determining a quality score for the received content item based at least in part on the interaction; and
generating a modified distribution of quality scores for the received content item by modifying the distribution of quality scores for the received content item to include the quality score of the received content item.

16. The method of claim 15, wherein an interaction indicating preference for a content item in the set of content items comprises a user of the digital magazine server accessing the content item for at least a threshold time interval.

17. The method of claim 15, wherein the quality score for the received content item is determined based on a ratio of a number of interactions indicating preference for the received content item to a normalization factor.

18. The method of claim 17, wherein the normalization factor comprises a total number of interactions with content items in the set of content items.

19. The method of claim 15, wherein the quality score for a content item in the set of content items is determined based on a ratio of the number of interactions indicating preference for the content item in the set of content items to a normalization factor.

20. The method of claim 19, wherein the normalization factor comprises a total number of interactions with the content items in the set of content items.

21. A method of determining quality of one or more content items for presentation by a digital magazine server, the method comprising:
receiving a content item;
determining a characteristic associated with the received content item;
identifying a set of content items previously presented to one or more users of a digital magazine server based at least in part on the characteristic associated with the received content item;
determining a number of interactions indicating preference for each content item in the set of content items;
determining a quality score for each content item in the set of content items, the quality score for a content item in the set of content items determined at least in part on a number of interactions indicating preference for the content item in the set of content items;
generating a distribution of quality scores for the received content item based on the determined quality scores for the content items in the set of content items;
receiving a query for quality of the received content item before an interaction with the received content item has been received; and
determining the quality of the received content item based at least in part on the distribution of quality scores for the received content item.

22. The method of claim 21, wherein an interaction indicating preference for a content item in the set of content items comprises a user of the digital magazine server accessing the content item for at least a threshold time interval.

23. The method of claim 21, wherein determining the quality score for the received content item based at least in part on the interaction comprises:
determining a total number of interactions indicating preference based on the number of interactions indicating preference for each content item in the set of content items; and
determining a ratio of the total number of interactions indicating preference and a normalization factor.

24. The method of claim 23, wherein the normalization factor comprises a total number of interactions with content items in the set of content items.

25. The method of claim 21, wherein the query for quality of the received content item comprises a specified quality score and a specified confidence.
